(19) United States
(12) Patent Application Publication
(10) Pub. No.: US 2011/0057010 A1
(43) Pub. Date: Mar. 10, 2011

(54) TAPE DISPENSER, A METHOD OF TAPING AND A SHOOTING MECHANISM

(75) Inventor: Coert Jonker, Bentveld (NL)

(73) Assignee: CECC Beheer B.V., Bentveld (NL)

(21) Appl. No.: 12/672,765

(22) PCT Filed: Aug. 11, 2008
(86) PCT No.: PCT/EP08/60547

§ 371 Date: Nov. 24, 2010

(30) Foreign Application Priority Data
Aug. 10, 2007 (EP) 07114180.8

(51) Int. Cl. B26F 3/02

(52) U.S. Cl. 225/39

(57) ABSTRACT

A tape dispenser comprises a housing (2), a tape feeder (3) for feeding tape (4), and at least a first and a second tape guiding surface for guiding the tape (4) from the tape feeder (3) in a taping direction. The tape guiding surfaces (6, 7) are separated from each other in the taping direction and located at the external side of the housing (2). The first and second tape guiding surfaces (6, 7) are oriented such that a common tangent plane touches the first tape guiding surface (6) in a first section (8) and the second tape guiding surface (7) in a second section (9). A portion of the second tape guiding surface (7) at a side of the second section (9) located remote from the first tape guiding surface (6) is angled with respect, to the tangent plane towards the housing (2), and the tape feeder (3) is disposed at the side of the first section located (8) remote from the second tape guiding surface (7). A cutter (13) for cutting the tape (4) is disposed between and movable with respect to the tape guiding surfaces (6, 7). Furthermore, engaging means (6) for enabling the tape (4) to be engaged with at least the first tape guiding surface (6) at least during a cutting operation.

The present invention relates to a tape dispenser according to the preamble of claim 1.

Such a tape dispenser is known from U.S. Pat. No. 4,253,905. The prior art hand-held tape dispenser is used for dispensing pressure-sensitive tape to be fixed into restricted accessible areas, such as window corners. The dispenser comprises a main frame supporting a tape roll. The tape is guided along a guide shoe past a pivotal cutter edge. The cutter edge is movable between a retracted position and an extended position. The tape can be positioned in a corner by a pivotal blade to which the cutter edge is provided. The cutting operation is performed by clamping the tape to a handle and pulling the tape at one side of the cutter edge by moving the handle such that the tape is cut in the corner by the cutter edge. Disadvantages of the known dispenser are that its mechanism is quite complex and that cutting of the tape in this way does not result in an acceptable cut edge of the tape.

The present invention aims to provide a tape dispenser which is capable to obtain an appropriate cut-off of the tape.

For this purpose the tape dispenser according to the invention is characterized in that the cutter is movable with respect to both tape guiding surfaces.

This appears to be advantageous in terms of cutting performance since the cutter moves with respect to the tape during the cutting operation. In this case the cutter cuts the tape rather than tearing it over a cutting edge, resulting in a good cut edge of the tape. This is especially relevant in case of applying masking tape on a window before painting the window frame, since the cut-off of the tape preferably ends along the edge of the window without having a rough shape. It is noted that the taping direction is defined as the direction of the tape with respect to the tape guiding surfaces at the tangent plane. The dispenser is also applicable for tape defined for other purposes. An advantage of the dispenser is that it allows to cut the tape without touching the surface to be taped.

The cutter may be movable in a direction substantially perpendicular to the tangent plane, since this appears to provide good cutting conditions. It is, however, also possible to cut the tape at a different angle with respect to the tangent plane, for example cutting in a direction at an angle of 20° with respect to the normal to the tangent plane. This may depend on the properties of the tape. Besides, when cutting at an angle which is not perpendicular to the tangent plane the cutter path is longer before a counter part is reached at the opposite side of the tangent plane compared to the case in which the cutter moves perpendicularly to the tangent plane.

In an advantageous embodiment the cutter is a blade-shaped element having a cutting edge formed along at least one projecting section of the cutter facing the tangent plane, preferably formed such that the cutter has a triangular cross-section at the cutting edge, as seen in the taping direction. This appears to improve the cutting conditions further. In practice the cutter may have a sharp tip facing the tangent plane. Alternatively, the cutter may have more than one projecting section. However, more than five projections reduces the cutting conditions, since this approaches a serrated edge and a serrated edge appears to have an adverse effect on the cut-off of the tape.

In a practical embodiment the cutter is operable by a trigger via a transmission, and the trigger is mounted to a handle for holding the dispenser. This enables the operator to activate the cutting operation in a simple way when he holds the dispenser by using the handle. It is noted that numerous alternatives of a trigger are possible, such as a press-button on the housing or the like.

In a preferred embodiment the first guiding surface is angled with respect to the tangent plane towards the housing between the first section and the tape feeder, because this shape enables the operator to press the tape between the first tape guiding surface and a second base, angled with respect to the base, in case when the tape is also pressed between the second tape guiding surface and the base so as to keep the tape in a tight condition between the first and second tape guiding surfaces before activating the cutter.

At least one of the first and second guiding surfaces may be convex in order to have a gradual surface of at least one of the first and second tape guiding surfaces. Such a shape avoids sharp edges to be pressed into the tape when the first and/or second tape guiding surfaces are pressed against the tape.

It is advantageous when the convex surface is formed by a circumferential wall of a roller which is rotatably connected to the housing and has an axis of rotation extending perpendicularly to the taping direction and parallel to the tangent plane, because the resistance between the tape and at least one of the first and second tape guiding surfaces is minimal in this case.

The convex surface may be located at a corner of the housing, which corner is formed by an outer wall of the housing located beyond the first and/or second tape guiding surface as seen along the respective surfaces from the cutter, and wherein the outer wall of the housing intersects the tangent plane, and wherein the convex surface projects from the outer wall of the housing adjacent to the convex surface. This embodiment provides the opportunity to tilt the housing about an axis extending perpendicularly to the taping direction and parallel to the tangent plane, while keeping one of the first and second tape guiding surfaces in contact with the base via the tape, wherein the portion of the housing adjacent to the first and/or second guiding surfaces does not hit the base. It means that the first and/or second guiding surfaces may press the tape against the base within a predetermined tilting range of the housing with respect to the base. For example, the housing may be tilted about the axis of rotation of the second roller before activating the cutter, or the housing may be tilted about the axis of rotation of the first roller after the cutting operation and at the start of a new taping operation.

The engaging means are at least partly formed by a portion of the first tape guiding surface, so as to enable the user to press the tape between the first tape guiding surface and a second base which is angled with respect to the base to which the first tape guiding surface can be engaged. In fact the engaging means in this embodiment are activated by the user who may press the tape between the first tape guiding surface and the second base so as to keep the tape tightly between both tape guiding surfaces before cutting the tape.

The housing may be provided with an adjustable handle for holding the dispenser, which handle is displaceable with respect to a remaining part of the housing in a transverse direction of the taping direction. This simplifies the taping operation for the operator, since the handle can be hold at a distance from the side of a window, for example.

In a practical embodiment the handle is tiltable with respect to the housing about an axis of rotation. This is a relatively simple structure and can be applied to tilt the handle in two opposite directions so as to use the tape dispenser along both left and right side walls. The axis of rotation may be substantially parallel to the taping direction.

The dispenser may be provided with indicating means to enable the user to tilt the housing with respect to the base by such an angle that upon cutting the tape at said angle results in that the cut tape ends at a predetermined location on the base.

When defining a first tangent plane being an outer tangent plane touching the first tape guiding surface and the housing and a second tangent plane being an outer tangent plane touching the second tape guiding surface and the housing, in a preferred embodiment of the dispenser both the angle between the tangent plane and the second tangent plane as seen outside the housing and the angle between the second tangent plane and the first tangent plane enclosing the housing are acute angles. Thus, the former angle forms a space outside the housing, whereas the latter angle forms a space in which the housing lies. The advantage of these geometric dimensions is that the dispenser can be handled in corners very easily, since it allows tilting the dispenser about an axis extending perpendicular to the taping direction and parallel to the tangent plane in opposite rotational directions.

When defining a first tangent plane being an outer tangent plane touching the first tape guiding surface and the housing, in an alternative embodiment an acute angle between the tangent plane and the first tangent plane as seen outside the housing may be larger than 30°, preferably larger than 45°.

When defining a second tangent plane being an outer tangent plane touching the second tape guiding surface and the housing, in an alternative embodiment an acute angle between the tangent plane and the second tangent plane as seen outside the housing may be larger than 30°, preferably larger than 45°.

Preferably, the dispenser is adapted such that in the vicinity of the first tape guiding surface and the second tape guiding surface the housing is spaced from the tangent plane, the first tangent plane and the second tangent plane. This means that the first tape guiding surface and the second tape guiding surface at least partly extend outside the housing as seen in a side view of the dispenser. This prevents the dispenser from touching a base surface first by the housing instead of the tape.

In a preferred embodiment the transmission is adapted such that the cutter is moved in a direction away from the tangent plane to the housing when displacing the trigger with respect to the housing, and wherein the dispenser comprises a resilient element which is positioned such that it is in engagement with the cutter and the housing when displacing the trigger with respect to the housing and such that it is biased upon said displacement of the cutter, and wherein the transmission comprises a disengagement mechanism for disengaging the cutter and the trigger after a certain displacement of the cutter and trigger. Due to these features a single displacement of the trigger in one direction first biases the resilient element and moves the cutter first in a direction opposite to a cutting direction, and then shoots the cutter in the cutting direction, which means that the tape will be cut efficiently. The cutting direction can be defined as the direction from the housing to the tangent plane.

In a practical embodiment the transmission may comprise a pivoting element which is rotatable about a pivoting axis with respect to the housing, wherein the trigger is connected to the pivoting element at a distance from the pivoting axis for pivoting it upon displacing the trigger, and wherein the pivoting element is provided with a hooking element including a hooking portion which is engageable with the cutter so as to displace the cutter upon pivoting the pivoting element.

The dispenser may be provided with a safety mechanism which avoids displacement of the cutter upon displacing the trigger with respect to the housing. This avoids an unintended cutting action.

The safety mechanism may be formed by the hooking element which is rotatably mounted to the pivoting element in this case, and wherein the safety mechanism comprises an actuator which, when activated, rotates the pivoting element such that the hooking portion is free from the cutter.

The safety mechanism may comprise a safety element for avoiding a displacement of the cutter upon displacing the trigger with respect to the housing, which safety element is movable with respect to the housing and projects from the housing. In a preferred embodiment the safety element is located such that it projects from the second tangent plane since it can be activated when tilting the dispenser such that the housing at the second tangent plane touches another surface.

The mechanism for shooting the cutter is not limited to the application in a dispenser. The invention is also related to a shooting mechanism for shooting an element comprising an element and a trigger, wherein the element can be operated by the trigger via a transmission, wherein the transmission is adapted such that the element is moved in a first direction when activating the trigger in a second direction, and wherein the mechanism comprises a resilient element which is positioned such that it is in engagement with the element when displacing the trigger in the second direction and such that the resilient element is biased upon said movement of the element, and wherein the transmission comprises a disengagement mechanism for disengaging the element and the trigger after a certain displacement of the element and trigger. When the disengagement mechanism is activated the element will be shot in a direction opposite to the first direction due to the energy release of the biased resilient element.

The invention also relates to a method of taping a base, wherein the tape is fed from a tape feeder and guided along a first and a second tape guiding surface in a taping direction between the tape guiding surfaces, whereas the first and second tape guiding surfaces are both moved opposite to the taping direction with respect to the base and wherein the tape is pressed onto the base by the first and/or second tape guiding surfaces, wherein the tape is cut between the tape guiding surfaces, wherein before cutting the tape, a tape portion already fixed to the base is held between the second tape guiding surface and the base, and the first tape guiding surface is moved away from the base whereas the tape between the first and second guiding surfaces is kept tightly. This way of cutting the tape appears to be advantageous in terms of cut edge of the tape and reliability of certainly cutting the tape by activating the cutter once.

More specifically the tape at the first tape guiding surface may be engaged between a second base, angled with respect to the base, and the first tape guiding surface so as to keep the tape between the first and second guiding surfaces tightly before the cutting operation. Thus, a contact surface between the first tape guiding surface and the tape at the second base can be rotated with respect to a contact surface between the tape and the second tape guiding surface at the base, whereas the second tape guiding surface can be pressed on the tape at the second base in order to press the tape at the first tape guiding surface against the first base and to press the tape at the second tape guiding surface against the second base in order to create a tightly stressed tape portion between the tape guiding surfaces, which portion is free from the base and the second base. This is a beneficial condition of the tape for the cutting operation.

The invention will hereafter be elucidated with reference to the schematic drawings showing embodiments of the invention by way of example.

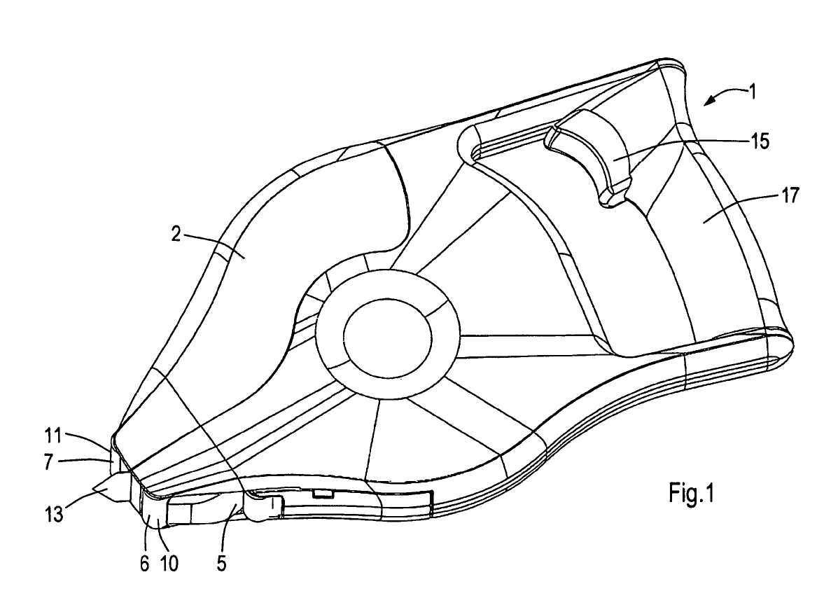

FIG. 1 is a perspective view of an embodiment of a tape dispenser according to the invention.

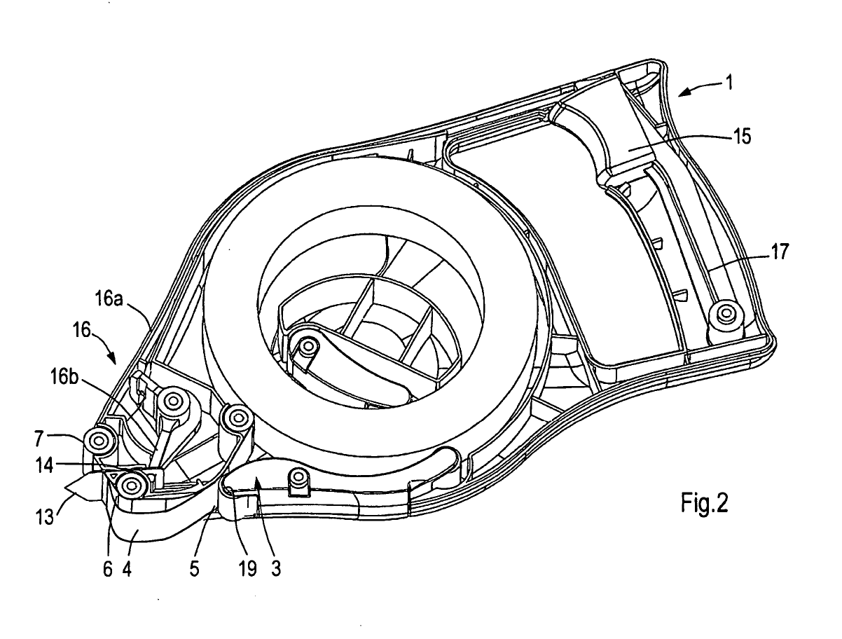

FIG. 2 is a perspective side view of a partly disassembled embodiment of FIG. 1 on a smaller scale.

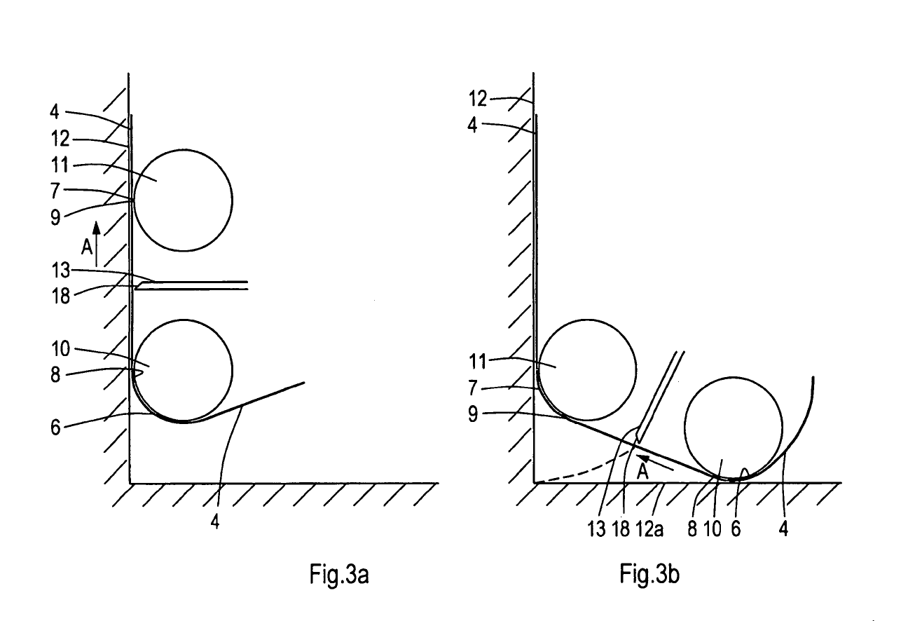

FIG. 3a-b are schematic drawings of a part of an alternative embodiment of the tape dispenser according to the invention, illustrating a condition of taping and cutting the tape, respectively.

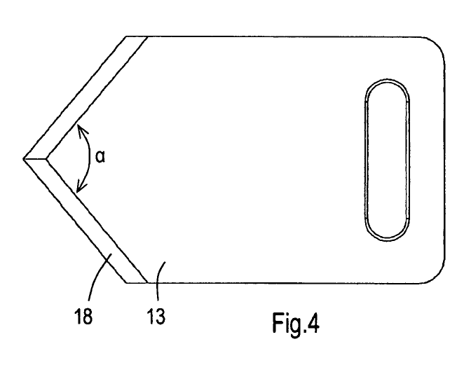

FIG. 4 is a schematic side view of a cutter of the embodiment of FIG. 1.

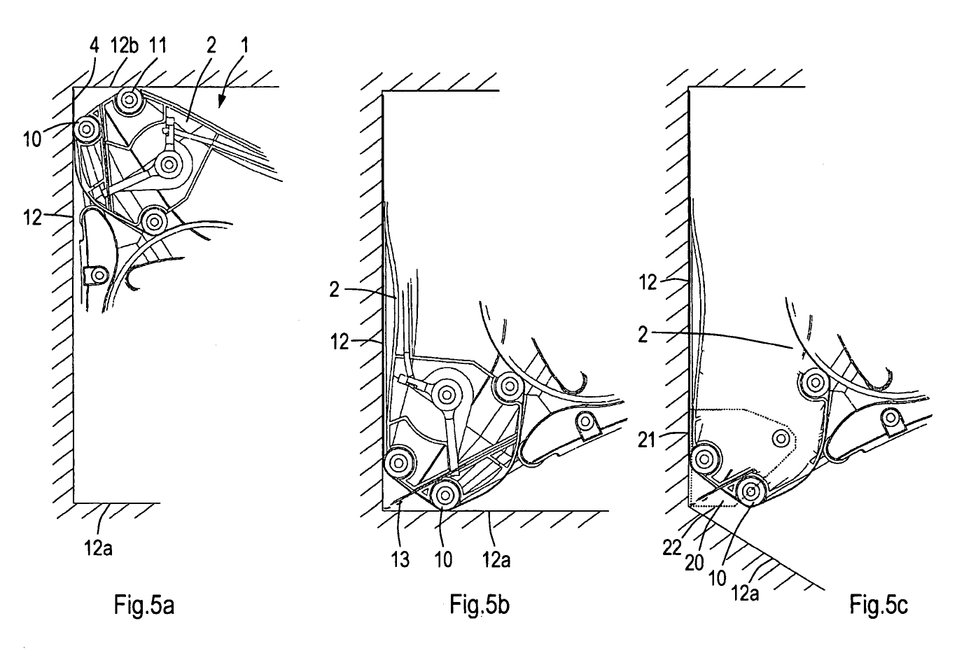

FIG. 5a-c are side views of the embodiment of FIG. 2, illustrating the taping method according to the invention.

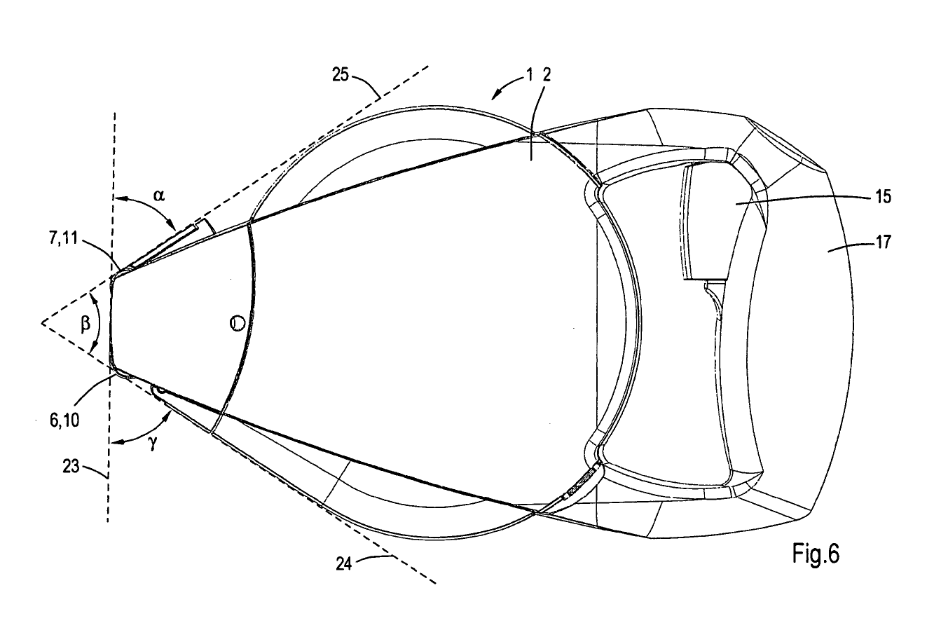

FIG. 6 is a schematic side view of another alternative embodiment of the tape dispenser.

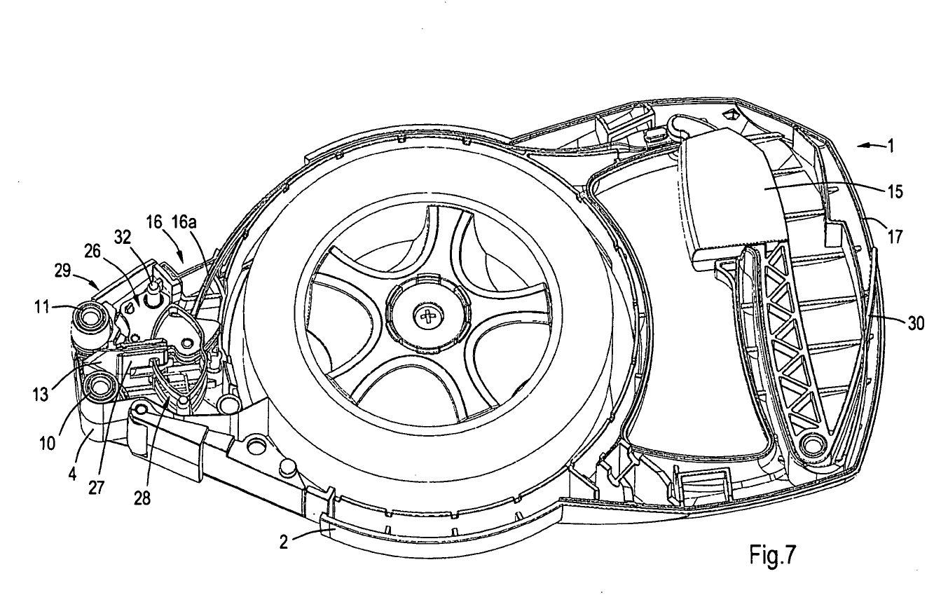

FIG. 7 is a perspective cut away view of the embodiment of FIG. 6.

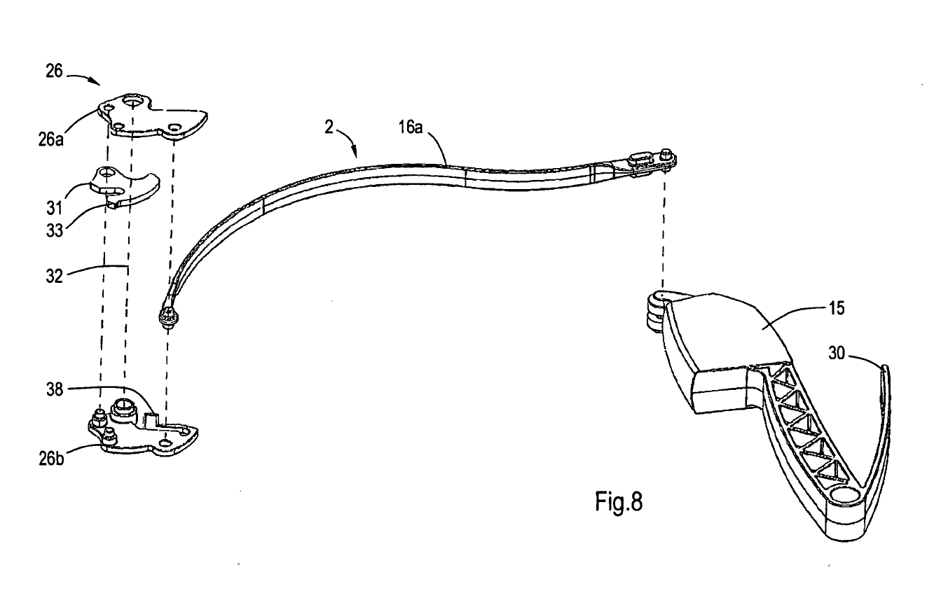

FIG. 8 is an exploded view of different parts of the pivoting element, the cable and the trigger.

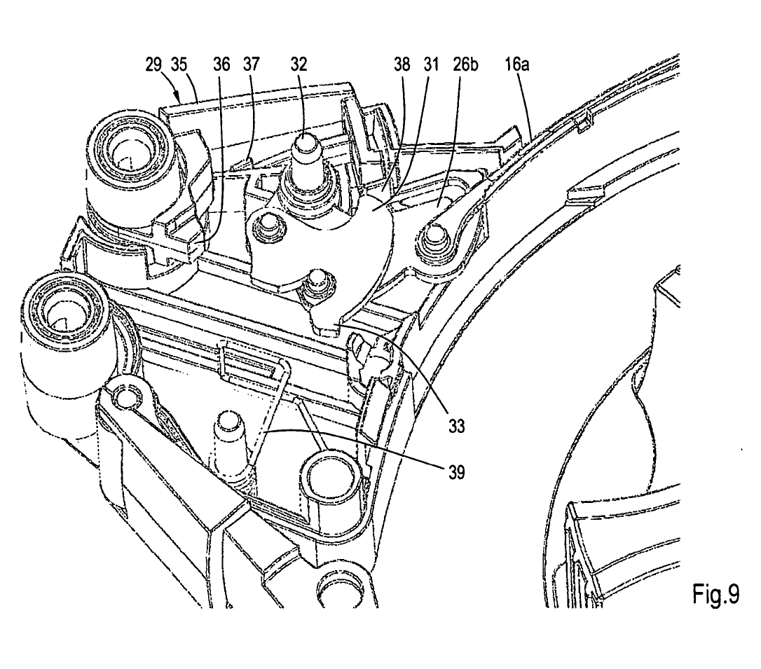

FIG. 9 is a perspective cut away view of a part of the embodiment of FIG. 7 on enlarged scale.

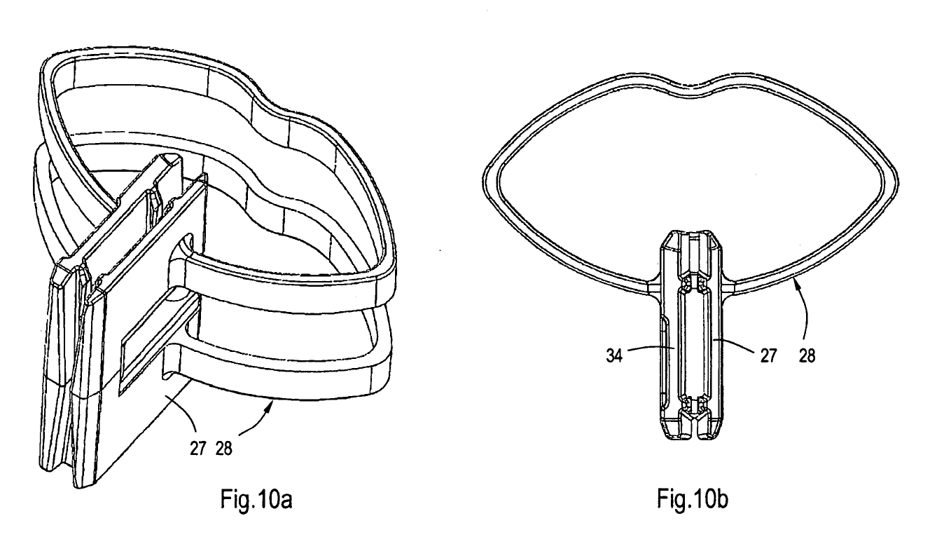

FIG. 10a is a perspective view of the cutter holder and the resilient element, and FIG. 10b is a top view thereof.

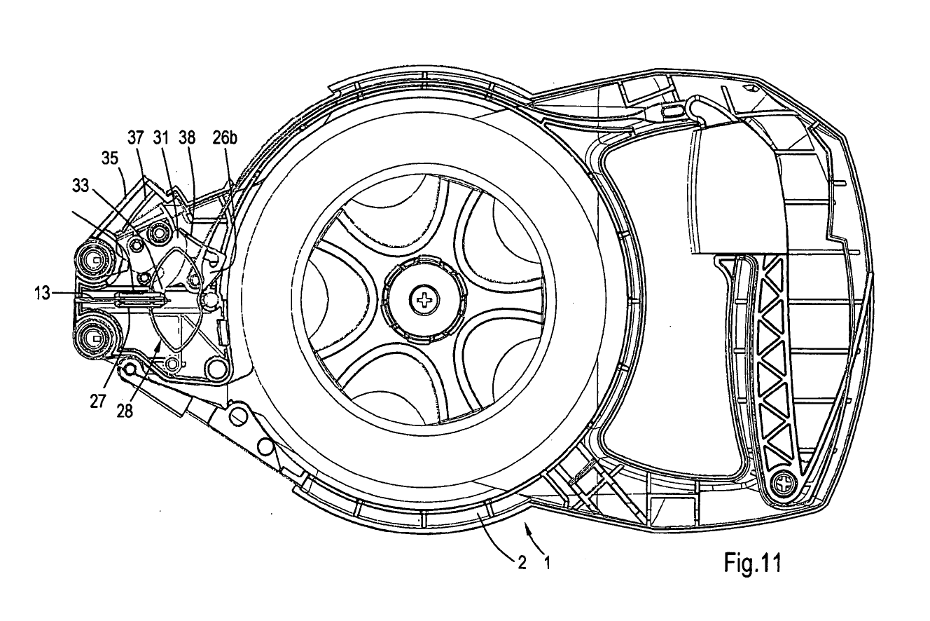

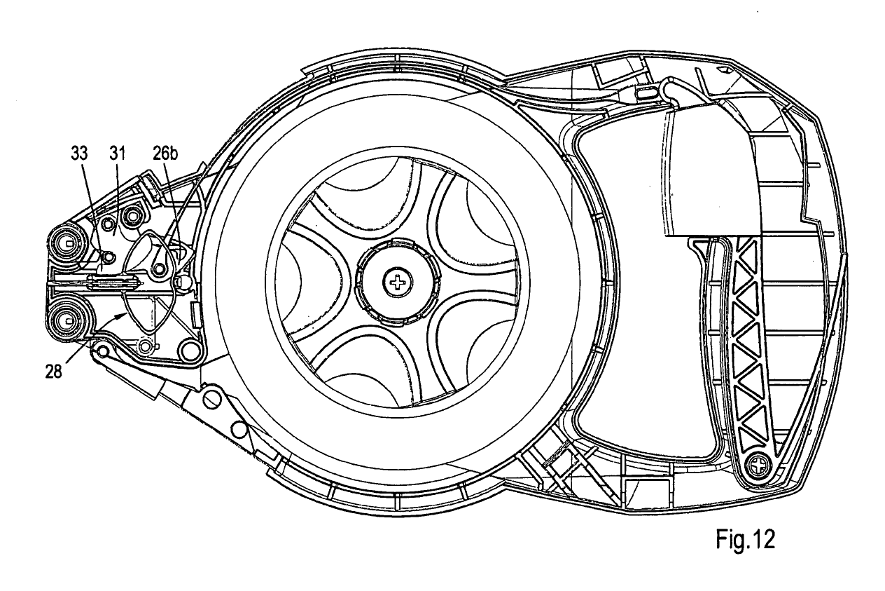

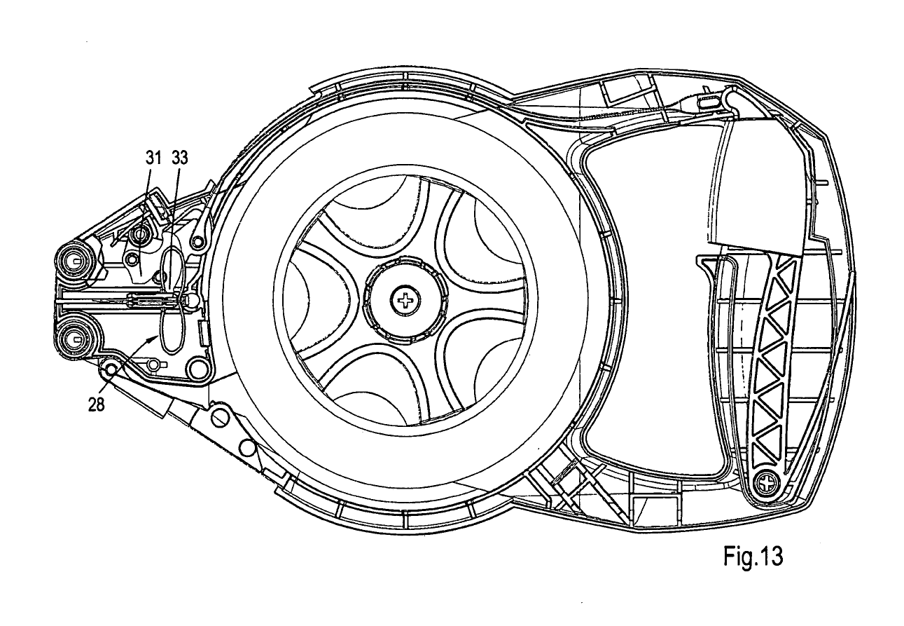

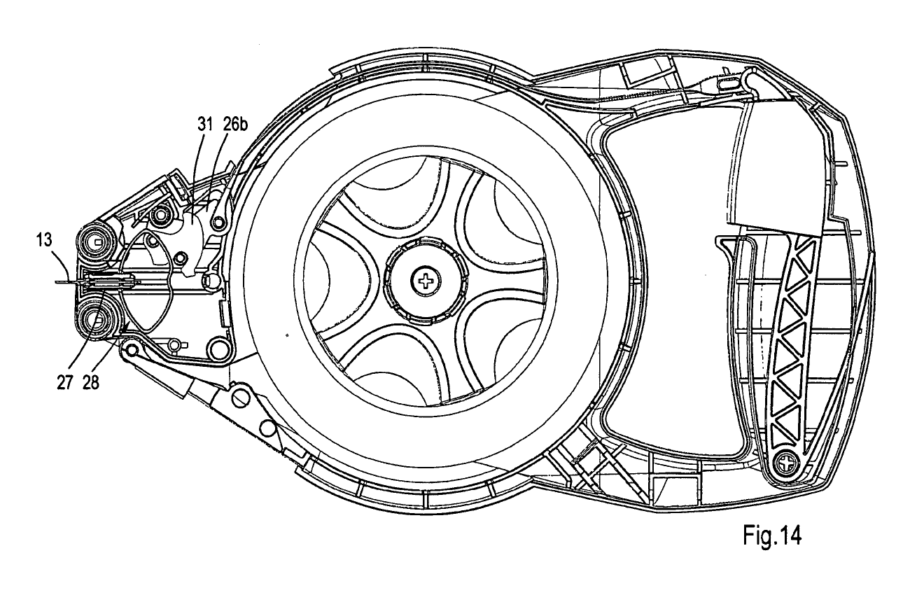

FIG. 11-14 are cut away side views of the embodiment of FIG. 7, showing sequential conditions when operating the dispenser.

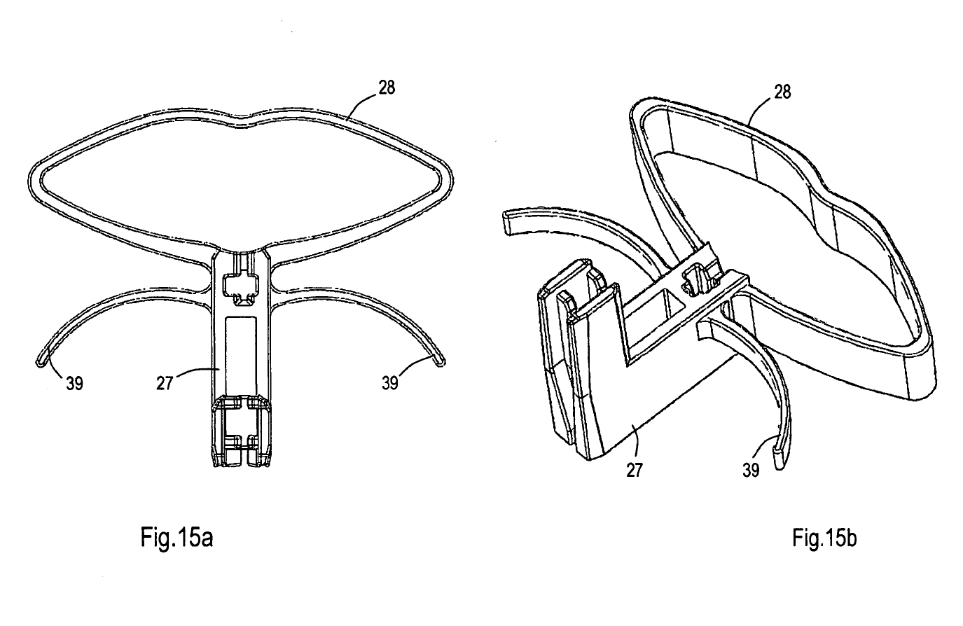

FIG. 15a is a top view of an alternative cutter holder and resilient element, and FIG. 15b is a perspective view thereof.

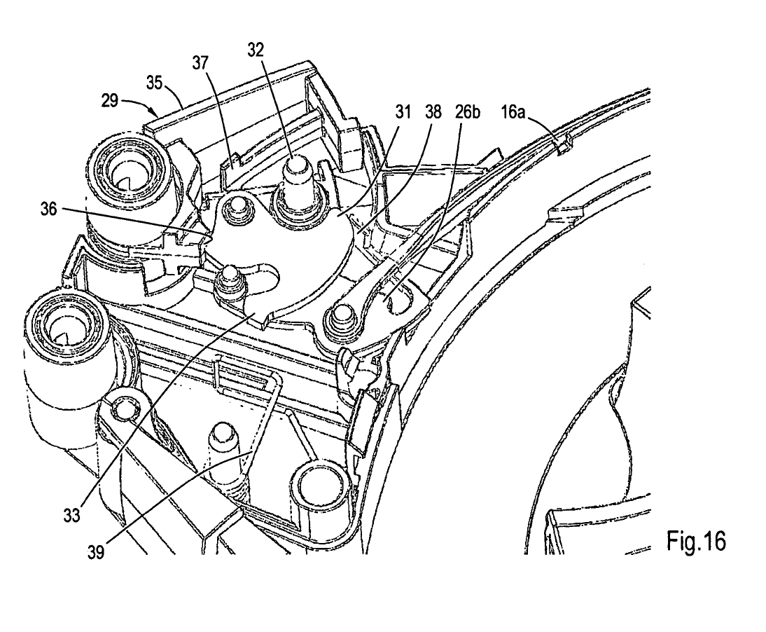

FIG. 16 is a similar view as FIG. 9, but illustrating an unlocked condition of the safety mechanism.

FIG. 1 shows an embodiment of a tape dispenser 1 according to the invention. The tape dispenser 1 is suitable, for example, for fixing pressure-sensitive masking tape on a window before painting in a simple way. The dispenser 1 comprises a housing 2, which accommodates a tape feeder 3 for feeding tape 4, such as shown in FIG. 2. The tape feeder 3 feeds the tape 4 to a tape output location 5, which is located at an external side of the housing 2. Thus, the tape 4 leaves the housing 2 at the tape output location 5, which may be a slot or the like, through which the tape 4 may pass. The housing may be made of a transparent material so as to enable the user to check the tape feeder from outside. For example, the user may inspect the quantity of tape which is still in the housing. The tape dispenser 1 is provided with a first tape guiding surface 6 and a second tape guiding surface 7 for guiding the tape 4 from the tape feeder 3 or tape output location 5 in a taping direction along the first and second tape guiding surfaces 6, 7. The taping direction is indicated by arrow A in FIG. 3a-b. Thus, the taping direction A is the direction the tape 4 moves between the first and second tape guiding surfaces 6, 7, respectively. During a taping operation the dispenser 1 moves in opposite direction of the taping direction A between the tape guiding surfaces 6, 7. The first and second tape guiding surfaces 6, 7 are oriented such that a common tangent plane touches the first tape guiding surface 6 in a first section 8 and the second tape guiding surface 7 in a second section 9. In practice, before cutting the tape 4, it will at least extend in the tangent plane between the first and second section 8, 9. In the embodiments shown in FIGS. 1-3 the tape guiding surfaces 6, 7 are separated from each other in the taping direction since the tape guiding surfaces 6, 7 are formed by first and second rollers 10, 11, respectively. The first and second rollers 10, 11 are rotatably connected to the housing 2 and have an axis of rotation extending parallel to the tangent plane and perpendicularly to the taping direction. It is noted that the first and second sections 8, 9 are formed by parallel lines in this case. If the first tape guiding surface 6 was a flat plane, for example, the first section 8 would be a plane instead of a line.

Since the tape guiding surfaces 6, 7 are formed by first and second rollers 10, 11, a portion of the second tape guiding surface 7 at a side of the second section 9 located remote from the first tape guiding surface 6 is angled with respect to the tangent plane towards the housing 2, and a portion of the first tape guiding surface 6 at a side of the first section 8 located remote from the second tape guiding surface 7 is angled with respect to the tangent plane towards the housing 2. Furthermore, the tape output location 5 is disposed at the side of the first section 8 located remote from the second tape guiding surface 7.

The first and second tape guiding surfaces 6, 7 are located at the external side of the housing 2. As illustrated in FIG. 1 the outer wall of the rollers 10, 11 partially project from the housing 2. The orientation of the first and second tape guiding surfaces 6, 7 enable a user to press the tape between the first tape guiding surface 6 and a base 12 to be taped, and/or the second tape guiding surface 7 and the base 12 to be taped (see FIG. 3a). In practice, when taping a part of the base 12 without corners the tape will be fixed by pressing the tape 4 to the base 12 by both tape guiding surfaces 6, 7. FIG. 3a shows the situation during taping, wherein the dispenser 1 is moved downwardly along a vertical wall (base 12) opposite to the taping direction A. Near corners the dispenser 1 can be used in another way, which will be explained hereinafter.

The tape dispenser 1 is also provided with a cutter 13 for cutting the tape 4. The cutter 13 is disposed between the rollers 10, 11 as seen from a direction perpendicular to the tangent plane. In the embodiment as shown in FIGS. 1, 2 and 5 the cutter 13 is movable in a direction which is angled with respect to a normal to the tangent plane. The cutter 13 is guided by cutter guides 14 to support and guide the cutter 13 and to avoid the cutter 13, which may comprise a relatively thin plate in practice, to be bent transversely when activated. The cutter 13 is operable by a trigger 15 via a transmission 16. In the embodiment shown in FIG. 2 the transmission 16 comprises a cable 16a which is connected to the trigger 15, on one hand, and to a pivot 16b which is connected to the cutter 13, on the other hand. However, alternative configurations of transmissions are conceivable. The trigger 15 is mounted to a handle 17 for holding the dispenser 1 by hand.

The handle 17 in the embodiment may be displaceable with respect to a remaining part of the housing 2 in a transverse direction (not shown). It may be tiltable about an axis of rotation and have three different positions with respect to the remaining part of the housing 2, for example at both sides of the housing in a direction perpendicular to the taping direction A and parallel to the tangent plane, and in a centre position in which the handle 17 is in alignment with the remaining part of the housing 2. In an alternative embodiment the axis of rotation may be close to the first and second rollers 10 and 11 such that the rollers 10, 11 are displaceable with respect to the tape feeder 3. In that case the tape feeder is not longer in alignment with the first and second guiding surfaces 6 and 7 under all conditions, which means that a transmission may be needed for properly guiding the tape 4 from the tape feeder along the first and second guiding surfaces 6, 7.

The cutter 13 is a blade-shaped element and has a cutting edge 18. The cutting edge 18 is formed at a projecting section of the cutter 13 having a triangular shape as seen in the taping direction A, such as illustrated in FIG. 4. Preferably, the top angle α of the triangle is within the range of 100-140° and more preferably about 120° since this appears to provide good cutting properties during a cutting operation.

The tape 4 can be cut by activating the cutter 13. According to the invention the cutter 13 is movable with respect to both tape guiding surfaces 6, 7, which means that the cutter 13 is moved with respect to the tape 4 during a cutting operation. The advantage of this feature is that the cutting operation appears to be improved, in particular when compared with a mechanism wherein the tape 4 is pulled at one side of a cutter 4 in order to cut the tape 4.

A cutting operation is illustrated in FIG. 3b. The tape 4 is guided by the first tape guiding surface 6 in the taping direction A past the cutter 13 and is further guided by the second tape guiding surface 7 and pressed onto the base 12 by pressing the tape 4 between the second tape guiding surface 7 and the base 12. Thus, in the situation as shown in FIG. 3b a portion of the tape 4 is already fixed to the base 12. FIG. 3b shows a second base 12a which is angled with respect to the base 12, in this case by 90°. In practice, the base 12 may be a window and the second base 12a may be a window sill. After reaching the corner between the base 12 and the second base 12a the first roller 10 will be rolled further along the second base 12a, whereas the second roller 11 still rolls downwardly along the base 12. Thus, the tape dispenser 1 is tilted about an axis extending perpendicularly to the taping direction A and parallel to the tangent plane, in this case being the axis of rotation of roller 11. In the situation as shown in FIG. 3b the tape 4 is also pressed between the first tape guiding surface 6 and the second base 12a. Thus the tape 4 is engaged with the first tape guiding surface 6, hence the first tape guiding surface 6 forms the engaging means for enabling the tape to be engaged with the first tape guiding surface 6. This means that the tape 4 can be kept tightly between the rollers 10, 11 which facilitates the subsequent cutting operation. The engaging means in this embodiment is in fact activated by the user who may press the tape 4 between the first tape guiding surface 6 and the second base 12b. It is noted that other engaging means are conceivable.

When the tape 4 has been cut, a portion of the tape will still project from the tape output location 5 outside the housing 2, see FIG. 2. This remaining portion outside the housing 2 extends beyond the first tape guiding surface 6 as seen from the tape output location 5. In a next taping operation the tape 4 can immediately be pressed against another base 12 or 12a by the first tape guiding surface 6, without necessarily pulling a tape portion out of the tape dispenser 1 from the tape feeder 3 first. Withdrawal of the portion of the tape 4 extending outside the housing 2 back into the housing 2 is avoided by a pressing member 19, which is shown in FIG. 2, and which clamps the tape 4 against the housing 2 near the tape output location 5.

FIG. 3b also illustrates that the location of the cutter 13 between the first and second tape guiding surfaces 6, 7 may be relevant for certain applications. In case of taping near a corner as shown in FIG. 3b the location of the cutter 13 with respect to the rollers 10, 11 and the angle about which the tape dispenser 1 is tilted with respect to the base 12 and the second base 12a should be such that when the tape 4 is cut, the tape portion not yet fixed to the base 12 can be pressed against the base 12 after the cutting operation and the cut edge of the tape 4 should preferably end in the corner. FIG. 3b illustrates the path of the cut-off portion of the tape 4 towards the base 12 by a curved dashed line.

The tape dispenser 1 according to the invention is easily tiltable in a corner due to its shape or geometric dimensions, as can be seen in for example FIGS. 1-3 and 5. This is further clarified in FIG. 6, which shows a schematic side view of an alternative embodiment of the tape dispenser 1 including several virtual planes 23, 24, 25. The tangent plane 23, which is already mentioned hereinbefore, touches the first tape guiding surface 6 or first roller 10 and the second tape guiding surface 7 or second roller 11. A first tangent plane 24 touches the first tape guiding surface 6 or first roller 10 and an outer location of the housing 2. Thus, the first tangent plane 24 forms an outer tangent plane touching the first tape guiding surface 6 and the housing 2. The first tangent plane 24 touches the housing 2 at such a location that an acute angle between the tangent plane 23 and the first tangent plane 24 is the smallest possible angle. The angle γ between the tangent plane 23 and the first tangent plane 24 determines the angle the dispenser 1 can have with respect to a base 12 whereas the first roller 10 can still be pressed against the base 12, see FIG. 5a, for example. If this angle would be small or even zero the orientations of the dispenser 1 with respect to the base 12 and the second base 12a as illustrated in FIGS. 5a and 5b could not be achieved.

A second tangent plane 25 (see FIG. 6) touches the second tape guiding surface 7 or second roller 11 and an outer location of the housing 2. Thus, the second tangent plane 25 forms an outer tangent plane touching the second tape guiding surface 7 and the housing 2. The second tangent plane 25 touches the housing 2 at such a location that an acute angle α between the tangent plane 23 and the second tangent plane 25 is the smallest possible angle. The angle α between the tangent plane 23 and the second tangent plane 25 determines the angle the dispenser 1 can have with respect to a base 12 whereas the second roller 11 can still be pressed against the base 12, see FIG. 5b, for example. If this angle would be small or even zero the orientations of the dispenser 1 with respect to the base 12 and a third base 12b as illustrated in FIG. 5a-c could not be achieved.

FIGS. 1, 2, 5 and 6 show that both the angle α between the tangent plane 23 and the second tangent plane 25, and the angle β between the second tangent plane 25 and the first tangent plane 24 are acute angles. More specifically the acute angle γ between the tangent plane 23 and the first tangent plane 24 is larger than 30° and preferably larger than 45°, whereas the acute angle α between the tangent plane 23 and the second tangent plane 25 is larger than 30°, preferably larger than 45°.

The dispenser 1 may be provided with indicating means to enable the user to tilt the housing 2 with respect to the base 12 and second base 12a so as to achieve this condition.

The indicating means may be formed by a part of the housing 2. This is illustrated in FIG. 5a-5c. FIG. 5a shows a base 12, a second base 12a and a third base 12b. The taping operation starts in the upper left corner, by pressing a portion of the tape 4 projecting from the housing 2 against the base 12. The dispenser 1 is moved downwardly along the base 12 such that the first roller 10 and/or the second roller 11 press the tape against the base 12. This is also shown in FIG. 3a. FIG. 5b shows the situation comparable to FIG. 3b. The housing 2 has such a shape that in the tilted position of the housing 2 with respect to the base 12 and second base 12a the outer wall of the housing 12 contacts the base 12, see FIG. 5b. When the first roller 10 hits the second base 12a such as shown in FIG. 5b, and when the cutter 13 is activated in this position, the tape 4 is cut at such a location that the tape 4 ends in the corner between the base 12 and second base 12a.

FIG. 5c shows a different configuration of the base 12 and the second base 12a. The angle between base 12 and second base 12a is larger than 90° in this case. The outer wall of the housing also contacts the base 12 as in FIG. 5b, but the tape 4 should be cut before the first roller 10 contacts the second base 12a when the dispenser 1 is moved downwardly. In order to achieve this, the indicating means are provided with an alignment element 20, which is rotatably mounted to the housing 2. The alignment element 20 has at least a first linear edge 21 and a second linear edge 22 which preferably form a corner of 90° with respect to each other. In the case as shown in FIG. 5c the dispenser 1 has been moved downwardly and the first linear edge 21 contacts the base 12. At a certain position of the dispenser with respect to base 12 the corner between the first linear edge 21 and the second linear edge 22 hits the corner between the base 12 and the second base 12a. The dimensions of the alignment element 20 are such that this is the right position to cut the tape 4, such that the cut tape ends in the corner between the base 12 and the second base 12a. Thus, the indicating means in this embodiment are formed by the shape of the housing 2 as well as by the alignment element 20.

Preferably, the housing 2 is relatively narrow as seen perpendicular to the taping direction A and parallel to the tangent plane. In particular the side walls of the housing 2 near the rollers 10, 11 may be thin so as to enable the user to fix the tape 4 very close to a side wall of the base 12, which is often required when masking tape is to be fixed onto a window before painting. Thus, the distance between the axial ends of the rollers 10, 11 and the external wall of the housing 2 in axial direction of the rollers 10, 11 near the rollers 10, 11 should be relatively short, for example 0-100 mm.

The dispenser 1 can also be provided with an adjusting mechanism (not shown) for adjusting the distance of the tape 4 to be taped parallel from the side wall. This might be advantageous, for example, in case of a sealing edge along a window edge adjacent to a window frame so as to tape the window adjacent to the sealing edge by guiding the dispenser along the frame. Furthermore, the tape dispenser 1 may be provided with a mechanism to facilitate replacement of the cutter 13. This can be a cover (not shown) on the housing in the vicinity of the cutter which can be easily opened to provide access to the cutter 13.

FIG. 7 shows a cut away view of another alternative embodiment of the dispenser 1 according to the invention. In this embodiment the cutter 13 is also operable by a trigger 15 via a transmission 16 as described above. In this case the cable 16a is connected to the cutter 13 via a pivoting element 26 and the cutter 13 is fixed to a cutter holder 27 which is resiliently connected to the housing 2 via a resilient member 28. The pivoting element 26, the cutter holder 27 and the resilient member 28 are connected to each other such and cooperate such that upon activating the trigger 15 the cutter 13 moves with respect to the housing 2 in the direction of a portion of the tape 4 which extends between the first and second roller 10, 11, after which the cutter 13 is automatically retracted into housing 2. The embodiment is also provided with a safety mechanism 29 to avoid unintended movement of the cutter 13 upon activating the trigger 15. Hereinafter the functioning of this embodiment will be described in more detail.

FIG. 8 shows different parts of the pivoting element 26, the cable 16a and the trigger 15. The trigger 15 is provided with a resilient trigger element 30 which serves to move the trigger 15 back after activation. The pivoting element 26 includes three parts: an upper pivoting element part 26a, a lower pivoting element part 26b, and a hooking element 31. The upper pivoting element part 26a and the lower pivoting element part 26b are fixed with respect to each other and are rotatable with respect to the housing 2 about a pivoting axis 32. The cable 16a is rotatably fixed to the pivoting element 26 at a distance from pivoting axis 32. The hooking element 31 is rotatably connected to and disposed between the upper pivoting element part 26a and the lower pivoting element part 26b. FIG. 9 shows a part of the dispenser 1 in which the upper pivoting element part 26a, the cutter 13, the cutter holder 4 and the resilient element 28 are removed for clarity reasons.

The hooking element 31 is provided with a hook portion 33 which fits into a slot 34 of the cutter holder 27, see FIG. 10b. Upon activating the trigger 15, the cable 16a pulls the hooking element 31 via the upper and lower pivoting element parts 26a, 26b such that it rotates about the pivoting axis 32. In the situation as illustrated in FIG. 9 the pivoting element 26 including the upper and lower pivoting element parts 26a, 26b and the hooking element 31 are coupled together due to a spring portion 38 of the lower pivoting element part 26b and rotate about the pivoting axis 32. The hook portion 33 and the cutter holder 27 are shaped such that during this movement the hook portion 33 pulls the cutter holder 27 away from the tangent plane 23 in the direction of the housing 2. As a consequence the resilient element 28 is pressed against the housing 2 until the hook portion 21 is moved away from the cutter holder 27 due to its rotational movement and looses its contact with the cutter holder 27. From that moment the cutter holder 27 moves at high speed in the direction of the tangent plane 23 and the cutter 13 cuts the tape 4 under operational conditions.

The safety mechanism 29 is made such that a lever 35 must be moved to the housing 2 in order to allow the hooking

The safety mechanism 29 comprises a movable safety element in the form of the lever 35 which projects from the housing 2 when the safety mechanism 29 is in the locked condition. More, specifically the lever 35 projects from the second tangent plane 25. The advantage of this location is that it is automatically activated when the dispenser 1 is tilted such that the second tangent plane 25 hits a basis, such as illustrated in FIGS. 5b and 5c.

FIG. 15 shows an alternative resilient element 28 and a return spring 39 as an integrated member with the cutter holder 27.

The advantage of the resilient element 28 as shown in FIG. 10 is that it creates a symmetric load on the cutter holder 27 when it is biased due tot its symmetric geometry with respect to the cutter holder 27.

Preferably, the cutter holder 27 is manufactured such that the cutter 13 is easily replaceable, for example by sliding the cutter 13 within the cutter holder 27 in a direction perpendicular to the direction of movement of the cutter holder 27 with respect to the housing 2.

From the foregoing, it will be clear that the invention provides a relatively simple tape dispenser which is capable to obtain an appropriate cut-off of the tape.

The invention is not limited to the embodiments shown in the drawings and described hereinbefore, which may be varied in different manners within the scope of the claims and their technical equivalents. For example, the rollers of the tape dispensers may be non-rotatable guiding surfaces, which may be smooth. The tape feeder may be drivable, for example by an electric motor. This reduces resistance of releasing the tape from the dispenser which may be desirable in applying the dispenser in a medical environment or when thin paper has to be fixed to a wall by using the tape dispenser. Furthermore, the features of the different embodiments may be combined. It is also possible that the tape is cut in a direction perpendicular to the taping direction and parallel to the tangent plane. Alternatively the tape can be cut by a laser beam or the location of cutting the tape may be determined by a laser beam. Furthermore, the housing may be manufactured such that a roll of tape may be replaced through an opening which is created by pivoting away a front portion of the dispenser at the side of the first and second rollers. It is also conceivable to move the cutter by means of an electric system.

1. A tape dispenser (1) comprising
a housing (2),
a tape feeder (3) for feeding tape (4),
at least a first (6) and a second tape guiding surface (7) for guiding the tape (4) from the tape feeder (3) in a taping direction (A), wherein the tape guiding surfaces (6, 7) are separated from each other in the taping direction (A) and located at the external side of the housing (2) so as to enable a user to press the tape (4) between the tape guiding surfaces (6, 7) and a base (12) to be taped, and the first and second tape guiding surfaces (6, 7) are oriented such that a common tangent plane (23) touches the first tape guiding surface (6) in a first section (8) and the second tape guiding surface (7) in a second section (9), and wherein a portion of the second tape guiding surface (7) at a side of the second section (9) located remote from the first tape guiding surface (6) is angled with respect to the tangent plane towards the housing (2), and wherein the tape feeder (3) is disposed at the side of the first section (8) located remote from the second tape guiding surface (7),
a cutter (13) for cutting the tape (4), disposed between the tape guiding surfaces (6, 7) as seen from a direction perpendicular to the tangent plane, and
engaging means for enabling the tape (4) to be engaged with at least the first tape guiding surface (6) at least during a cutting operation,
characterized in that the cutter (13) is movable with respect to both tape guiding surfaces (6, 7).

2. A tape dispenser (1) according to claim 1, wherein the cutter (13) is movable in a direction substantially perpendicular to the tangent plane (23).

3. A tape dispenser (1) according claim 1 or 2, wherein the cutter (13) is a blade-shaped element having a cutting edge (18) formed along at least one projecting section of the cutter (13) facing the tangent plane (23), preferably formed such that the cutter (13) has a triangular shape at the cutting edge (18), as seen in the taping direction.

4. A tape dispenser (1) according to one of the preceding claims, wherein the cutter (13) is operable by a trigger (15) via a transmission (16), which trigger (15) is mounted to a handle (17) for holding the dispenser (1).

5. A tape dispenser (1) according to one of the preceding claims, wherein the first guiding surface (6) is angled with respect to the tangent plane towards the housing (2) between the first section (8) and the tape feeder (3).

6. A tape dispenser (1) according to one of the preceding claims, wherein at least one of the first and second guiding surfaces (6, 7) is convex.

7. A tape dispenser (1) according to claim 6, wherein the convex surface (6, 7) is formed by a circumferential wall of a roller (10, 11) rotatably connected to the housing (2) and having an axis of rotation extending perpendicularly to the taping direction and parallel to the tangent plane (23).

8. A tape dispenser (1) according to claim 6 or 7, wherein the convex surface is located at a corner of the housing (2), which corner is formed by an outer wall of the housing (2) located beyond the first and/or second tape guiding surface (6, 7) as seen along the respective surfaces from the cutter (13), the outer wall of the housing (2) intersects the tangent plane (23), and wherein the convex surface projects from the outer wall of the housing (2) adjacent to the convex surface.

9. A tape dispenser (1) according to one of the preceding claims in combination with claim 5, wherein the engaging means are at least partly formed by a portion of the first tape guiding surface (6), so as to enable the user to press the tape (4) between the first tape guiding surface (6) and a second base (12a) which is angled with respect to the base (12) to which the second tape guiding surface (7) can be engaged.

10. A tape dispenser (1) according to one of the preceding claims, wherein the housing (2) is provided with an adjustable handle (17) for holding the dispenser (1), which handle (17) is displaceable with respect to a remaining part of the housing (2) in a transverse direction of the taping direction.

11. A tape dispenser (1) according to claim 10, wherein the handle (17) is tiltable with respect to the housing (2) about an axis of rotation.

12. A tape dispenser (1) according to one of the preceding claims, wherein the dispenser (1) is provided with indicating means to enable the user to tilt the housing (2) with respect to the base 12 by such an angle that upon cutting the tape (4) at said angle results in that the cut tape (4) ends at a predetermined location on the base (12).

13. A method of taping a base (12), wherein the tape (4) is fed from a tape feeder (3) and guided along a first and a second tape guiding surface (6, 7) in a taping direction (A) between the tape guiding surfaces (6, 7), whereas the first and second tape guiding surfaces (6, 7) are both moved opposite to the taping direction with respect to the base and wherein the tape (4) is pressed onto the base (12) by the first and/or second tape guiding surface (6, 7), wherein the tape (4) is cut between the tape guiding surfaces (6, 7), wherein before cutting the tape (4), a tape portion already fixed to the base (12) is held between the second tape guiding surface (7) and the base (12), and the first tape guiding surface (6) is moved away from the base (12) whereas the tape (4) between the first and second guiding surfaces (6, 7) is kept tightly.

14. A method of taping according to claim 13, wherein before cutting the tape (4), the tape (4) at the first tape guiding surface (6) is engaged between a second base (12a), angled with respect to the base (12), and the first tape guiding surface (6) so as to keep the tape (4) between the first and second guiding surfaces (6, 7) tightly before the cutting operation.

15. A tape dispenser (1) according to one of the claims 1-12, wherein a first tangent plane (24) is an outer tangent plane touching the first tape guiding surface (6) and the housing (2) and a second tangent plane (25) is an outer tangent plane touching the second tape guiding surface (7) and the housing (2), wherein both the angle (α) between the tangent plane (23) and the second tangent plane (25) as seen outside the housing (2) and the angle (β) between the second tangent plane (25) and the first tangent plane (24) enclosing the housing (2) are acute angles.

16. A tape dispenser (1) according to one of the claims 1-12, wherein a first tangent plane (24) is an outer tangent plane touching the first tape guiding surface (6) and the housing (2), wherein an acute angle (γ) between the tangent plane (23) and the first tangent plane (24) as seen outside the housing (2) is larger than 30°, preferably larger than 45°.

17. A tape dispenser (1) according to one of the claims 1-12 and claim 7, wherein a second tangent plane (25) is an outer tangent plane touching the second tape guiding surface (7) and the housing (2), wherein an acute angle (α) between the tangent plane (23) and the second tangent plane (25) as seen outside the housing (2) is larger than 30°, preferably larger than 45°.

18. A tape dispenser (1) according to claim 4, and one of the claim 1-12 or 15-17, wherein the transmission (16) is adapted such that the cutter (13) is moved in a direction away from the tangent plane (23) to the housing (2) when displacing the trigger (15) with respect to the housing (2), and wherein the dispenser (1) comprises a resilient element (28) which is positioned such that it is in engagement with the cutter (13) and the housing (2) when displacing the trigger (15) with respect to the housing (2) and such that it is biased upon said displacement of the cutter (13), and wherein the transmission (16) comprises a disengagement mechanism (26, 27, 31, 34) for disengaging the cutter (13) and the trigger (15) after a certain displacement of the cutter (13) and trigger (15).

19. A tape dispenser (1) according to claim 18, wherein the transmission (16) comprises a pivoting element (26) which is rotatable about a pivoting axis (32) with respect to the housing (2), wherein the trigger (15) is connected to the pivoting element (26) at a distance from the pivoting axis (32) for pivoting it upon displacing the trigger (15), and wherein the pivoting element (26) is provided with a hooking element (31) including a hooking portion (33) which is engageable with the cutter (13) so as to displace the cutter (13) upon pivoting the pivoting element (26).

20. A tape dispenser (1) according to claim 18 or 19, wherein the dispenser (1) is provided with a safety mechanism (29) which avoids displacement of the cutter (13) upon displacing the trigger (15) with respect to the housing (2).

21. A tape dispenser (1) according to claim 20, wherein the safety mechanism (29) is formed by the hooking element (31) which is rotatably mounted to the pivoting element (26), and wherein the safety mechanism comprises an actuator (36) which, when activated, rotates the pivoting element (31) such that the hooking portion (33) is free from the cutter (13).

22. A tape dispenser (1) according to claim 20 or 21, wherein the safety mechanism (29) comprises a safety element (35) for avoiding a displacement of the cutter (13) upon displacing the trigger (15) with respect to the housing (2), which safety element is movable with respect to the housing (2) and projects from the housing (2).

23. A shooting mechanism for shooting an element (13) comprising an element (13) and a trigger (15), wherein the element (13) can be operated by the trigger (15) via a transmission (16), wherein the transmission (16) is adapted such that the element (13) is moved in a first direction when activating the trigger (15) in a second direction, and wherein the mechanism comprises a resilient element (28) which is positioned such that it is in engagement with the element (13) when displacing the trigger (15) in the second direction such that the resilient element and (28) is biased upon said movement of the element (13), and wherein the transmission (16) comprises a disengagement mechanism (26, 27, 31, 34) for disengaging the element (13) and the trigger (15) after a certain displacement of the element (13) and trigger (15).
